(19) United States
(12) Patent Application Publication
(10) Pub. No.: US 2011/0033761 A1
(43) Pub. Date: Feb. 10, 2011

(54) Fuel Cell System With at Least One Fuel Cell

(76) Inventor: Markus Walter, Dettingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/739,104

(22) PCT Filed: Oct. 9, 2008
(86) PCT No.: PCT/EP08/08524

§ 371 Date: Nov. 1, 2010

(30) Foreign Application Priority Data
Oct. 22, 2007 (DE) 10-2007-050-377.8

(51) Int. Cl. H01M 8/04

(52) U.S. Cl. 429/428

(57) ABSTRACT

In a fuel cell system with at least one fuel cell connected to electrical connection lines, the fuel cell can be short-circuited in the event of an emergency cut-out being required.

### BACKGROUND AND SUMMARY OF THE INVENTION

This application is a national stage of PCT International Application No. PCT/EP2008/008524, filed Oct. 9, 2008, which claims priority under 35 U.S.C. §119 to German Patent Application No. 10 2007 050 377.8, filed Oct. 22, 2007, the entire disclosure of which is herein expressly incorporated by reference.

The invention relates to a fuel cell system with at least one fuel cell, which is connected to electrical connection lines.

When using batteries as energy sources in a vehicle, it is known that a two-pole switch-off or separation of the system from electrical energy sources (the batteries) is carried out by opening electromechanical switches. Control devices for these batteries usually comprise two gates, which separate the battery from the contacts guided to the outside. This is presently also realized with a fuel cell system in a corresponding manner.

A disadvantage of such an embodiment is that these are relatively elaborate with regard to components, as an actuator for fulfilling the safety standard has to be present at least in a twofold manner. A further disadvantage of these embodiments is that high voltages are present after the separation, which can endanger people. A disadvantage of the known embodiments with gates is that gates have a reduced reliability, once they have been charged with a current having a large amperage. In addition, high requirements have to be fulfilled when switching off direct currents. Not least, a relatively large installation space is also required for the plurality of components, as well as a high assembly effort. The activation is furthermore relatively elaborate, and by means of the plurality of the components, a higher weight is also given. All these disadvantages also contribute not least to increased costs.

One object of the present invention is to provide a fuel cell system, where the safety of the adjustment of operating states can be achieved with a reduced effort.

This and other objects and advantages are achieved by the fuel cell system according to the invention, which comprises at least one fuel cell that is connected to electrical connection lines, and can be short-circuited in the event of an emergency cut-out. It is thus provided here that a short circuit can be generated in a deliberate, and thus a desired, manner. Exactly with an emergency cut-out (as is e.g., necessary in an accident situation), a desired operating state can thus be achieved reliably and with little effort. By short-circuiting the fuel cell, inadmissible high voltages, which endanger people, are avoided, so that no danger (in the sense of an electric shock) can come from the voltage source. Not least, the effort for the actuation, the assembly effort, and the space requirement can be reduced thereby. Furthermore, a component reduction and thus also a weight reduction can be enabled by the at least two actuators, which are no longer necessary.

The term “connection” within the scope of the present invention includes not only electrical connections in the closer sense, but also e.g., current bars, hollow conductors or the like.

The fuel cell system preferably comprises a short-circuit device, which has a pyrotechnically activatable mechanical switch.

It can also be provided that a short-circuit device has an electromechanically activatable switch.

It can furthermore be provided that a short-circuit device has a semiconductor switch, whose resistance is definably reduced for short-circuiting the fuel cell.

It can furthermore be provided that a short-circuit device has a spark gap, in particular a gas deflector. Gas deflectors are also known to the expert under the term gas discharge deflector, spark gap or gas-filled separation spark gap. The gas deflector can be formed as an element that can be triggered by at least one ignition electrode. The at least one ignition electrode can be connected at least intermittently to a device, which is provided to generate a triggering pulse (current or voltage pulse) in an electrically conductive manner.

The short-circuit device, in particular the spark gap, can be designed for a multiple generation of a short-circuit, which leads to a minimizing of the maintenance costs and the maintenance effort.

The short-circuit device can alternatively be designed for a one-off generation of a short-circuit.

The short-circuit device has at least one additional switching element, which is formed for switching off the system in other operating phases different to the emergency cut-out. These different other operating phases for the emergency cut-out are for example present during the maintenance or with the usual service of these systems.

This additional switching element is preferably assigned to an inverter or a current transformer. Instead of inverters or current transformers, boost converters or buck converters or combinations thereof are also considered. It can be provided in particular that the additional switching element is a switch or preferably a transistor.

The electrical voltage at the connection lines conducted to the outside is lower than 60 V (preferably lower than 30 V, particularly preferred almost 0 V) after at least 60 s (preferably 5 s, particularly preferred 3 s) after the short-circuiting of the fuel cell.

It can also be provided that the system comprises a plurality of fuel cells, a so-called fuel cell stack, which can be short-circuited by an electrically conducting element, which can be fitted for bridging all fuel cells for the emergency cut-out and which can be electrically connected to the connection lines.

A situation in which an emergency cut-out is necessary can be recognized by a specific sensor system. Just when the fuel cell system is formed as a mobile system and is arranged in a vehicle, an accident of the vehicle can for example be detected. Acceleration sensors are for example provided for this, wherein, in dependence of recognizing the accident situation, an emergency cut-out is then defined by the acceleration sensors and the fuel cell can be short-circuited in this connection. This is only an exemplary sensor system, by means of which a specific situation can be recognized for an emergency cut-out. In addition or alternatively, it can for example also be provided that an air bag triggering defines a subsequent emergency cut-out of the fuel cell system.

By means of the deliberately and actively triggered short-circuit of a fuel cell during an emergency cut-out, the voltage acting to the outside will be almost 0 V. The remaining residual charge is transferred in the energy source, the fuel cell itself, which causes in particular a heating of the fuel cell. By this procedure, the control of an emergency cut-out can be enabled very efficiently and nevertheless with little effort during the operation of fuel cells, so as to be able to discharge the fuel cell. The safety standards for preventing of high voltages moving outwards can furthermore be fulfilled thereby.

A considerable weight saving compared to conventional embodiments with at least two actuators and complex activation thereof can be achieved further.

Electrical energy sources with a voltage higher than 60 V (voltage limit according to the standard) are in particular subject to high safety criteria, as these electrical voltages can be life-threatening.

In the case of batteries where these high voltages can occur, separating switches are thus used, but these are connected to a corresponding high effort and high costs due to possible extremely high direct currents. Additionally, a two-pole separation has to be provided due to a one-sided closure between the energy source and the vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a first embodiment of a fuel cell system according to the invention;

FIG. 2 is a second embodiment of a fuel cell system according to the invention;

FIG. 3 is a third embodiment of a fuel cell system according to the invention; and

FIG. 4 is a fourth embodiment of a fuel cell system according to the invention.

### DETAILED DESCRIPTION OF THE DRAWINGS

In the figures, the same elements or elements having the same function are provided with the same reference numerals.

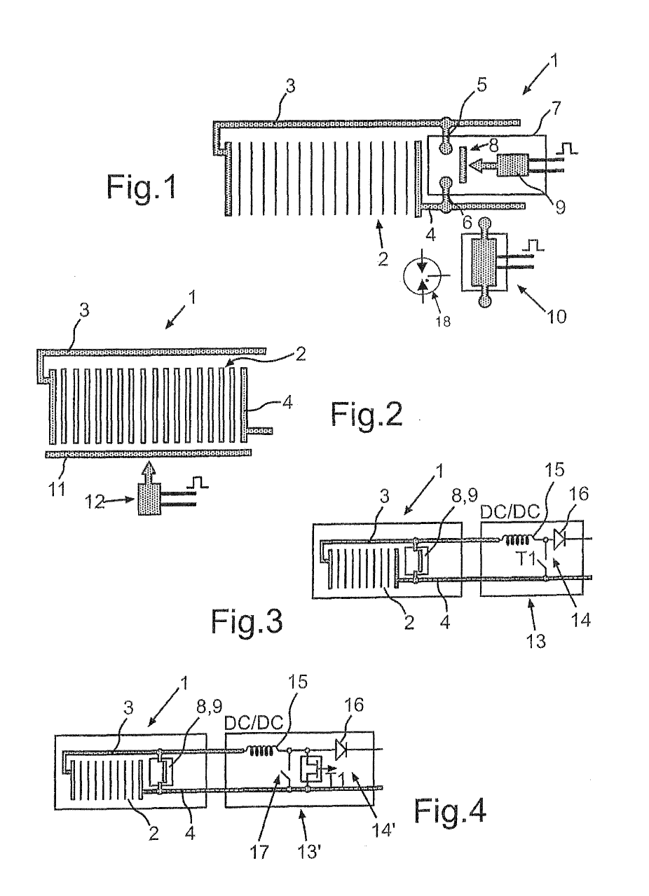

In FIG. 1, a fuel cell system 1 is shown in a schematic depiction, which shows only the components of the fuel cell system 1 which are sufficient for understanding the invention. The fuel cell system 1 is formed as a mobile fuel cell system and is arranged in a vehicle. The fuel cell system 1 comprises a fuel cell stack 2 with a plurality of fuel cells in the embodiment, which are preferably formed as PEM fuel cells.

The fuel cell stack 2 is contacted with a first electrical connection line 3 and a second electrical connection line 4.

The first connection line 3 has an electrical contact 5 outside the fuel cell stack 2, and the second connection line 4 has an electrical contact 6.

The fuel cell system 1 further comprises a short-circuit device 7 with a switch 8, which can be actuated via an actuator 9.

In FIG. 1, the opened state of the short-circuit device 7 is shown.

For generating the short-circuit of the fuel cell stack 2, the switch 8 is contacted electrically via the actuator 9 with the electrical contacts 5 and 6 and the short-circuit is generated thereby.

In FIG. 1 is realized a pyrotechnically actuated mechanical switch by the switch 8 and the actuator 9.

It can also be provided that the switch 8 is realized as an electromechanically actuated switch, which is normally “open” or “closed”.

As an alternative to a pyrotechnically actuated mechanical switch or an electromechanically actuated switch, a semiconductor switch 10 can also be provided, as is shown in an exemplary manner in FIG. 1 in addition to the fuel cell system 1. This semiconductor switch 10 can then be arranged in the short-circuit device 7 instead of the switch 8 and the actuator 9.

The semiconductor switch 10 can be destroyed in a targeted manner for generating the short-circuit of the fuel cell stack 2, so that it changes from a high resistance state to a low resistance state.

Semiconductor switches which can be switched reversibly, e.g., thyristors, are also considered. These open even by themselves, namely when the current is equal to zero.

Furthermore, switches are also considered, in which an alloy designed especially for this purpose is melted on, which then produces a short-circuit.

A spark gap can also be provided for generating the short-circuit of the fuel cell stack 2 as an alternative to semiconductor switches, to a pyrotechnically actuated mechanical switch and to an electromechanically actuated switch.

In addition to the fuel cell system 1, a spark gap, in particular a gas deflector 18 is shown. The gas deflector 18 can be arranged in the short-circuit device 7 instead of the switch 8 and the switching element 9. The gas deflector 18 can have at least an electrode, not described in detail, which can be electrically connected at least intermittently to a device for generating an actuation pulse.

In FIG. 2 is shown a further embodiment of a fuel cell system 1, where the fuel cell stack 2 can be short-circuited via an electrically conducting element 11. This electrically conducting element 11 can be mounted for an emergency cut-out in such a manner that it contacts the two connection lines 3 and 4 and bridges the fuel cells. In this embodiment a conducting connection is produced transversely over the fuel cell 2, so that each individual fuel cell is short-circuited and can discharge. A possible damaging pole change of individual fuel cells is thereby prevented. The problem of a short-circuit of high voltage is additionally reduced to one with an electrical voltage smaller than 1 V.

The residual charge of a fuel cell stack 2 is manageable when adjusting the gas supply, which is required in any case in an emergency, and does not represent a danger potential with regard to overheating. For this reason, the fuel cell stack 2 can be short-circuited for fulfilling the condition of a terminal voltage smaller than 60 V of the fuel cell stack 2.

The alternatives explained for the embodiment according to FIG. 1 relating to a pyrotechnically actuable mechanical switch 8 or a semiconductor switch 10, are virtually formed as one-off switching elements. This is in contrast to the embodiments explained in FIG. 1 of an electromechanically actuated switch 8 or to the switching mechanism explained in FIG. 2 with the electrically conducting element 11, which can be actuated via an actuator 12. These last-mentioned embodiments are designed as multiple switching elements and can thus be activated repeatedly for generating a short-circuit.

With the embodiments mentioned initially, which can be designated as one-time switching elements, it is additionally provided to implement a reliable principle of the cut-out for normal running times and for the service operation. This is for example shown in an embodiment according to FIG. 3. An additional switching element 14 can be provided for this instead of the usual gates, which is assigned to a current transformer or inverter 13. This current transformer or inverter 13 further comprises an inductivity 15 and a diode 16. The additional switching element 14 can be a switch or for example also a transistor. In the embodiment according to FIG. 3, an electronic switch 14 is realized with regard to this, which is already present in the current transformer or inverter 13. This does not have to be dimensioned to the requirements of an accident, so that no additional effort is required in the sense of additional components.

In FIG. 4, a further embodiment is shown in this connection, where a transistor 14′ is assigned to the current transformer or the inverter 13′. A further switch 17 is additionally provided. In the case shown here, an additional switch 14′ is shown, which is closed in a currentless manner. This has the advantage that the voltage freedom (that is, the short-circuit) is possible without active actuation. The otherwise conventionally used transistors in converters are currentless open transistors.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Fuel cell system
2 Fuel cell stack
3,4 Electrical connection lines
5,6 Electrical contacting
7 Short-circuit device
8 Switch
9, 12 Actuators
10 Semiconductor switch
11 Conducting element
13, 13′ Inverter or current transformer
14 Switching element
14′ Transistor
15 Inductivity
16 Diode
17 Switch
18 Gas deflector

1-12. (canceled)

13. A fuel cell system comprising:
at least one fuel cell which is connected to electrical connection lines; and
a short-circuit device for emergency cut-out of the at least one fuel cell;
wherein, which short-circuit device has one of a pyrotechnically actuatable mechanical switch, an electromechanically actuatable switch, and a spark gap.

14. The fuel cell system according to claim 13, where:
the emergency cut-out has a spark gap; and
the spark gap is formed as a gas deflector.

15. The fuel cell system according to claim 13, wherein the short-circuit device accommodates a one-off generation of a short-circuit.

16. The fuel cell system according to claim 13, wherein the short-circuit device has an additional switching element which is formed for switching the system off in operating phases other than an emergency cut-out.

17. The fuel cell system according to claim 16, wherein the switching element is assigned to one of an inverter or a current transformer.

18. The fuel cell system according to claim 16, wherein the switching element is a transistor.

19. The fuel cell system according to claim 13, wherein the short-circuit device is configured to repeatedly generate a short-circuit.

20. The fuel cell system according to claim 13, wherein the electrical voltage at the connection lines conducted to the outside is lower than 60 V within 60 s after the short-circuiting of the fuel cell.

21. The fuel cell system according to claim 13, wherein electrical voltage at the connection lines conducted to the outside is approximately 0 V after short-circuiting of the fuel cell.

22. The fuel cell system according to claim 13, wherein electrical voltage at the connection lines conducted to the outside is smaller than 60 V within 3 s after short-circuiting of the fuel cell.

23. The fuel cell system according to claim 13, wherein electrical voltage at the connection lines conducted to the outside is approximately 0 V within 3 s after the short-circuiting of the fuel cell.

24. The fuel cell system according to claim 13, wherein:
the system comprises a plurality of fuel cells;
said fuel cells can be short-circuited by an electrically conductive element, which can be fitted for bridging all fuel cells for the emergency cut-out and which can be electrically connected to the connection lines.
